(19) United States
(12) Patent Application Publication
(10) Pub. No.: US 2015/0274023 A1
(43) Pub. Date: Oct. 1, 2015

(54) CONTACTLESS CHARGING SYSTEM FOR CHARGING A MOTOR VEHICLE BATTERY

(71) Applicant: RENAULT s.a.s, Boulogne-Billancourt (FR)

(72) Inventors: Jeanne Houivet, Paris (FR); Hugues Doffin, Buc (FR)

(73) Assignee: RENAULT s.a.s, Boulogne-Billancourt (FR)

(21) Appl. No.: 14/432,906

(22) PCT Filed: Sep. 24, 2013
(86) PCT No.: PCT/FR2013/052232

§ 371 Date: Apr. 1, 2015

(30) Foreign Application Priority Data
Oct. 1, 2012 (FR) 1259248

(51) Int. Cl. B60L 11/18

(52) U.S. Cl. CPC B60L 11/182

(57) ABSTRACT

A contactless charging system for charging a motor vehicle battery, including a primary induction circuit outside the motor vehicle powered by an electric power network, a secondary induction circuit installed on the motor vehicle and coupled to the battery via a rectifier bridge, a controlled switch mechanism configured to put the secondary induction circuit into short circuit without putting the battery into short circuit when there is an electrical malfunction on board the motor vehicle, and a controller configured to cut off power to the primary induction circuit when detecting a short circuit in the secondary induction circuit.

The invention relates to the contactless charging of a battery of an automobile vehicle and more particularly, the safety of an automobile vehicle in the case of an electrical malfunction during the contactless charging of the battery.

A system for contactless charging of a battery of an automobile vehicle generally takes the form of a primary inductive circuit in the ground and of a secondary inductive circuit installed onboard the vehicle. The transfer of energy between the two inductive circuits takes place by electromagnetic induction. With respect to a charging system with an electrical outlet, such a charging system offers the following advantages: it allows, on the one hand, the comfort and the ergonomics of the user to be improved owing to the fact that there is no risk of forgetting the connection nor any constraints associated with the weight of the plug. It allows, on the other hand, a tolerance in positioning of the charging system and an efficiency equivalent to the efficiency of a wired charging system to be obtained. Finally, it allows the system always to be situated at the resonance frequency of the inductive circuit forming each of the emitter and receiver loops of the contactless charging system, and the best possible efficiency to be guaranteed thanks to the adaptation of the frequency of the system.

One of the limitations of a contactless charging system is the time for communication between the primary system integrated into the ground and the secondary system in the vehicle. This communication may take place via wifi or zigbee for example. The communication time leads to a delay in the transfer of information, notably in the direction of transfer going from the vehicle toward the ground. Since the power is supplied by the primary inductive circuit in the ground, a delay in the transmission of information between the vehicle and the ground can lead to a power transmitted by the primary inductive circuit from the ground for an additional time which can damage the equipment onboard the vehicle.

For example, in the case of a battery which gets disconnected from the charging system, the relays coupled to the terminals of the battery open; there is therefore no longer any electrical load connected to consume the energy transmitted by the primary inductive circuit from the ground to the secondary inductive circuit onboard the vehicle. Degradations of the electrical circuits may occur if the ground continues to send power while the battery is disconnected for example, or else if the primary inductive circuit in the ground does not detect a malfunction onboard the vehicle sufficiently early. This case arises since the information on the state of the onboard system is communicated to the ground by a means of wireless communications which results in a delay in the transmission of information.

Indeed, the time taken to detect a malfunction of the battery by the vehicle and then to receive a message providing notification of this malfunction at the charge controller in the ground becomes too large for it to be ensured that the onboard charger does not undergo deteriorations.

A method is known from the document US 2010/020777 allowing the relays coupled to the battery to be closed only when the power from an external supply by induction is detected. However, no solution is mentioned in the case where the relays of the battery open because of a malfunction.

The document U.S. Pat. No. 6,037,745 discloses a device for receiving an electromagnetic wave for the charging of a battery designed to be installed onboard an automobile vehicle. This device comprises a resonant inductive circuit coupled to the battery via a bridge rectifier, and means for short-circuiting the resonant circuit without short-circuiting the battery when a malfunction occurs.

The aim of the invention is to provide a system for contactless charging of a battery of an automobile vehicle guaranteeing, when an electrical malfunction occurs onboard the vehicle, the interruption of the power emitted by the primary inductive circuit in the ground before there is any risk of damage onboard the vehicle.

According to one aspect of the invention, a device is provided for receiving an electromagnetic wave for the charging of a battery designed to be installed onboard an automobile vehicle, comprising a secondary inductive circuit coupled to the battery via a bridge rectifier.

According to one general feature of the invention, the said receiving device comprises controlled interruption means designed to short-circuit the secondary inductive circuit without short-circuiting the battery when an electrical malfunction occurs onboard the automobile vehicle.

According to another aspect of the invention, a device is provided for emitting an electromagnetic wave for the charging of a battery of an automobile vehicle comprising a primary inductive circuit powered via a power supply network.

According to a general feature of the invention, the said emission device comprises control means designed to interrupt the power supply to the primary inductive circuit when they detect a short-circuit of the secondary inductive circuit.

According to yet another aspect of the invention, in one embodiment, a system is provided for contactless charging of a battery of an automobile vehicle comprising a receiving device such as defined hereinabove, installed onboard the automobile vehicle, and an emission device such as defined hereinabove disposed outside of the automobile vehicle. A charging system is thus provided comprising a primary inductive circuit outside of the automobile vehicle powered by an electrical supply network, a secondary inductive circuit installed onboard the automobile vehicle and coupled to the battery via a bridge rectifier, and controlled interruption means designed to short-circuit the secondary inductive circuit without short-circuiting the battery when an electrical malfunction occurs onboard the automobile vehicle, and more particularly when a malfunction occurs in the part of the charging system coupled to the battery, and control means designed to interrupt the supply of power to the primary inductive circuit when they detect a short-circuit of the secondary inductive circuit, and all this detection taking place without using the means of wireless communications between the ground and the vehicle.

During a normal operation of the charging system, the use of a bridge rectifier allows the current at the output of the inductive secondary circuit to be rectified in order to supply power to the battery and thus to recharge it. When an electrical malfunction occurs in the automobile vehicle, the controlled interruption means allow the secondary inductive circuit to be short-circuited and the bridge rectifier prevents the short-circuiting of the battery.

The bridge rectifier comprises two diodes whose cathodes are coupled to the positive terminal of the battery, their anodes being connected to two diodes whose anodes are coupled to the negative terminal of the battery. In the case where the controlled interruption means comprise two controlled switches designed to short-circuit the secondary inductive circuit, each of the two diodes whose anodes are coupled to the negative terminal of the battery is coupled in parallel with one of the controlled switches. Since the two diodes with a cathode coupled to the positive terminal of the battery are not short-circuited, the battery is maintained electrically disconnected from the secondary inductive circuit.

As a variant, instead of the controlled switches, the controlled interruption means can comprise thyristors reverse-connected in parallel or else a triac, which is/are connected in parallel with the input of the bridge rectifier.

Preferably, the receiving device comprises a control capacitor for the controlled interruption means coupled in parallel with the battery via relays, in case of a loss of the 12V supply from the vehicle.

This control capacitor allows the controlled interruption means to be powered without having to use the 12 V supply of the automobile vehicle. Indeed, the voltage across the terminals of the capacitor increases when the battery is disconnected from the secondary inductive circuit since it is this capacitor which recovers the energy supplied by the system in the ground, independently of a power supply circuit other than the secondary inductive circuit. The secondary inductive circuit can thus be short-circuited and the charging system can consequently be interrupted even if the electrical malfunction reaches the 12V supply of the vehicle.

The control capacitor can correspond to a filtering and smoothing capacitor connected in parallel with the output of the bridge rectifier.

The receiving device of the charging system can comprise two relays each coupled to a respective terminal of the battery between the battery and the controlled bridge rectifier. The relays allow the battery to be disconnected from the secondary inductive circuit if needed. In a case where the relays do not open correctly while there is an electrical malfunction, the architecture of the bridge rectifier allows the battery to be electrically disconnected from the secondary inductive circuit when the secondary inductive circuit is short-circuited.

The emission device of the system may advantageously comprise an inverter coupled to the primary inductive circuit and controlled by the control means which can comprise a current sensor designed to measure the current flowing in the primary inductive circuit and means for regulation of the current designed to control the opening and the closing of the switches of the inverter and to adjust the duty cycle of the inverter and the frequency of the current generated by the inverter in order to lock it to the resonance of the inductive system.

Advantageously, the control means of the system may comprise a comparison module designed to compare the measured current with a current threshold depending on the level of charge of the battery.

The receiving device of the system may also comprise at least one fuse coupled to one of the terminals of the battery. The fuse provides an additional safety feature guaranteeing that no short-circuit of the battery is possible even in the case of a defective component on the bridge rectifier. In addition, the fuse allows a malfunction of the two relays to be pre-empted, and thus the battery to be disconnected from the rest of the secondary inductive circuit.

According to another aspect, in one implementation, a safe contactless method is provided for charging a battery of an automobile vehicle by inductive transfer of power between a primary inductive circuit outside of the automobile vehicle and a secondary inductive circuit installed onboard the vehicle and coupled to the battery.

According to a general feature of the invention, the secondary inductive circuit is short-circuited when an electrical malfunction occurs onboard the automobile vehicle, and a command is sent for the disconnection of the primary inductive circuit from the electrical supply network when the short-circuit of the secondary inductive circuit is detected by interruption of the sending of the switching setpoints to the primary inverter for example.

Preferably, the short-circuiting of the secondary inductive circuit is controlled using the voltage across the terminals of a capacitor connected in parallel with the battery via relays.

Advantageously, the current flowing in the primary inductive circuit is measured, and the short-circuit of the secondary inductive circuit is detected based on the variation of the current flowing in the primary inductive circuit.

The primary circuit preferably operating at its resonance frequency by regulation, this frequency is continuously corrected since it can vary in the course of the same charging process. If objects are put in the vehicle for example, the weight increases, the height to the ground decreases, and hence the distance between the primary inductive circuit and the secondary inductive circuit is modified, which implies a modification of the resonance frequency. The frequency setpoint is continuously sent to the inverter, which implies the optimization of the time for detection of short-circuit in the ground.

The measured current is advantageously compared with a current threshold depending on the level of charge of the battery.

Other advantages and features of the invention will become apparent upon examining the detailed description of a non-limiting embodiment and a non-limiting implementation and the appended drawings, in which:

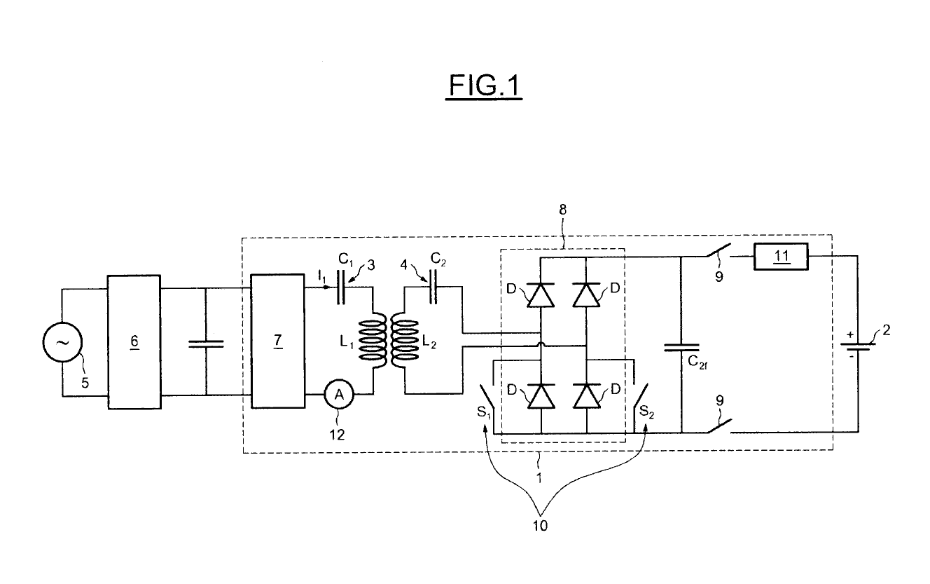

FIG. 1 shows schematically a system for contactless charging of a battery of an automobile vehicle according to one embodiment of the invention;

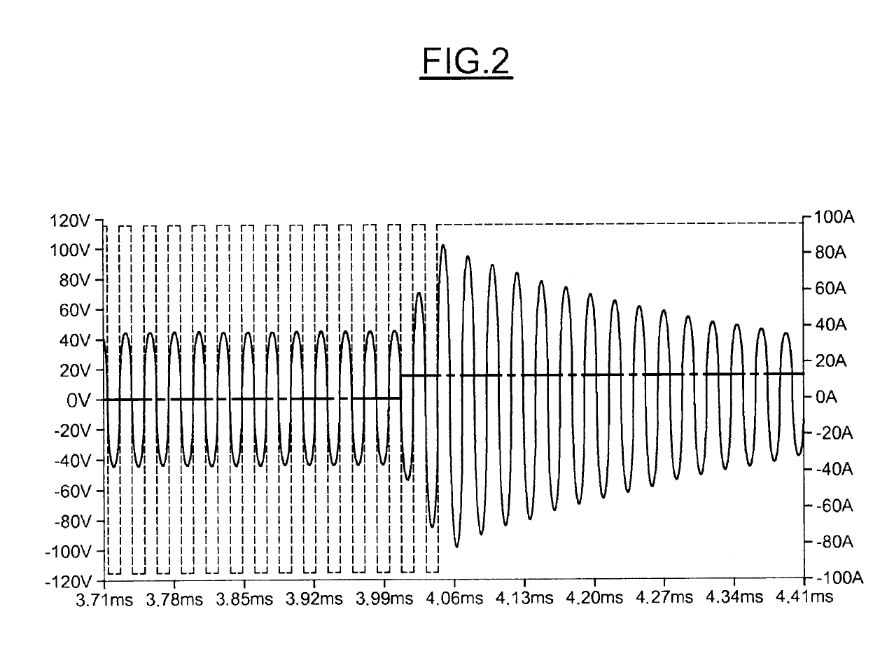

FIG. 2 presents a graph illustrating the voltage variation across the terminals of the primary inductive circuit, the voltage variation across the terminals of the secondary inductive circuit, and the variation of current in the primary inductive circuit, when an electrical malfunction occurs in the secondary, with the invention;

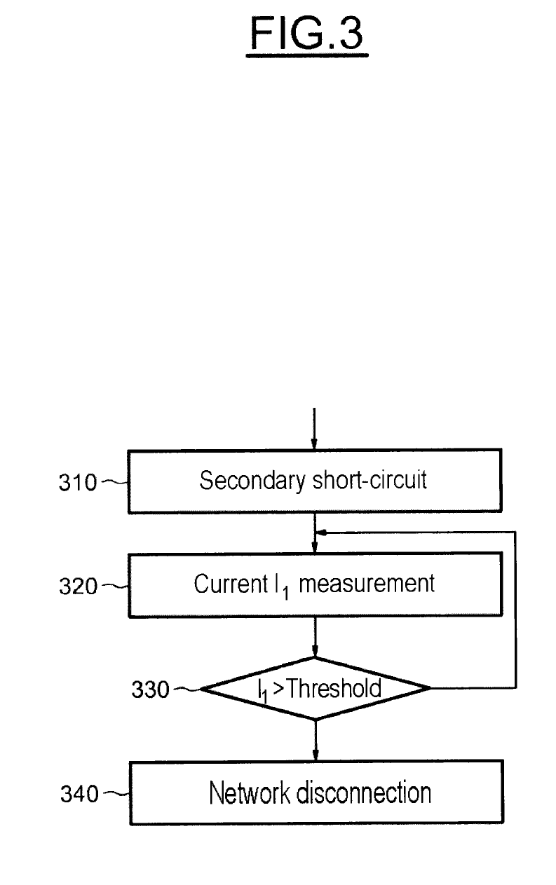

FIG. 3 presents a flow diagram of a safe contactless method for charging of a battery of an automobile vehicle according to one implementation of the invention.

FIG. 1 shows a system 1 for contactless charging of a battery 2 of an automobile vehicle according to one embodiment of the invention.

The contactless charging system 1 comprises a primary inductive circuit 3 installed in the ground, for example in a parking space, and a secondary inductive circuit 4 installed onboard the automobile vehicle.

The primary inductive circuit 3 is coupled to an electrical supply network 5 supplying the power needed for the primary inductive circuit 3 via a rectifier stage 6 and an inverter 7. The secondary inductive circuit 4 is coupled to the battery 2 via a bridge rectifier 8 and two relays 9 each coupled to one terminal of the battery 2. The relays 9 can open in the case of electrical malfunction in the vehicle which allows the battery 2 to be electrically decoupled from the secondary inductive circuit 4.

The primary inductive circuit 3 and the secondary inductive circuit 4 each comprise an inductive element, L₁ and L₂ respectively, and a capacitive element, C₁ and C₂ respectively, connected in series.

The bridge rectifier 8 comprises a diode bridge D coupled at the input to the secondary inductive circuit 4 and coupled at the output to the battery 2 via the relays 9. The diode bridge D comprises two diodes whose cathode is coupled to the positive terminal “+” of the battery 2 and two diodes D whose anode is coupled to the negative terminal “−” of the battery 2.

In the example illustrated in FIG. 1, the bridge rectifier 8 is coupled to interruption means 10 comprising two controlled switches S₁ and S₂. The two controlled switches S₁ and S₂ are respectively coupled in parallel with one of the diodes whose anode is coupled to the negative terminal “−” of the battery 2.

The charging system 1 also comprises a control capacitor C_{2f} providing the power for the control of the controlled switches S₁ and S₂. The control capacitor C_{2f} is coupled in parallel with the output of the bridge rectifier 8 and also with the battery 2 via the relays 9. One relay 9 is thus coupled between a “+” or “−”terminal of the battery 9 and one terminal of the control capacitor C_{2f}. The control capacitor C_{2f} may, during normal operation of the contactless charging system 1, in other words with no electrical malfunction, also act as a filtering and smoothing capacitor for the output voltage of the bridge rectifier 8.

When at least one of the relays 9 is opened, the battery 2 is electrically decoupled from the secondary inductive circuit 4. The voltage across the terminals of the control capacitor C_{2f} then increases rapidly given that there is no longer any load coupled to the secondary inductive circuit 4 to absorb the power delivered. When the control voltage C_{2f} reaches a trigger threshold, the controlled switches S₁ and S₂ of the controlled interruption means 10 are closed so as to short-circuit the two diodes D whose anode is coupled to the negative terminal “−” of the battery 2, and thus to short-circuit the secondary inductive circuit 4.

Since the two diodes D whose cathode is coupled to the positive terminal “+” of the battery 2 are not short-circuited, the battery 2 is maintained electrically disconnected from the secondary inductive circuit 4.

The system 1 also comprises, in the example illustrated, a fuse 11 coupled in series between the positive terminal “+” and the relay 9 to which this terminal is coupled. The fuse 11 thus guarantees that the battery 2 is not short-circuited even if a component of the bridge rectifier 8 is defective.

The short-circuiting of the secondary inductive circuit 4 has an influence on the behavior of the primary inductive circuit 3. Indeed, the current flowing in the primary inductive circuit 3 is modified both in amplitude and in waveform.

The contactless charging system 1 comprises a current sensor 12 measuring the current I₁ flowing in the primary inductive circuit 3. The short-circuiting of the secondary inductive circuit 4 is detected as soon as the current is seen to increase.

In order not to confuse an increase in current due to the short-circuiting of the secondary inductive circuit 4 and a modification of the resonance frequency of the system due to a modification of the environment, such as bringing the two inductive circuits 3 and 4 closer for example, the detection threshold is chosen so as to be higher than the peak current of the primary inductive circuit 3.

The power delivered by the primary inductive circuit 3 varies as a function of the level of charge of the battery 2, notably because the impedance of the battery 2 varies as it is charged, and the power setpoint required by the battery 2 varies over time, while its voltage increases as it is charged. Thus, the amplitude of the current I₁ flowing in the primary inductive circuit 3 varies as a function of the level of charge of the battery 2. The detection threshold for the short-circuiting of the secondary inductive circuit 4 also varies as a function of the level of charge of the battery 2 in order to optimize the time and the efficiency of the detection.

For example, as illustrated in FIG. 2, for a peak amplitude of 40 A for the current at the resonance frequency of the primary inductive circuit 3, the current threshold for the detection may be chosen equal to 80 A. It can be seen in FIG. 2 that, when the secondary inductive circuit 4 is short-circuited, in other words when the voltage V_{cc-secondary} corresponding to the short-circuiting setpoint, the mixed dashed line, goes from 0 to 1, the amplitude of the current I₁, the solid line, flowing in the primary inductive circuit 3 increases until it reaches an amplitude of 80 A. When the amplitude of the current reaches 80 A, the supply of power to the primary inductive circuit 3 via the power supply network 5 is interrupted. On the graph in FIG. 2, this corresponds to a constant voltage, the dotted line, across the terminals of the primary inductive circuit 3, and a drop in the amplitude of the current I₁ flowing in the primary inductive circuit 3.

In the case illustrated in FIG. 1, where the electrical supply network 5 used is not a DC power supply but a rectifier, ripple appears in the current flowing in the primary inductive circuit 3. In this case, the peaks of current due to the ripple associated with the rectification of the network must not be confused with a peak of primary current I₁ linked to an electrical malfunction occurring on the secondary inductive circuit 4. In this case, the detection threshold is chosen to be sufficiently high so as not to risk interrupting the charging because of the ripple, and the current measurement comprises a determination of the current variation. If the variation determined corresponds to an increase in current over a time that is very short compared with the period of the oscillations, then the power supply to the primary inductive circuit 3 is interrupted. The detection of a rapid variation of the current may be achieved by a peak detection for example.

FIG. 3 shows a flow diagram of a safe contactless method for charging a battery 2 of an automobile vehicle according to one implementation of the invention.

When a battery 2 is charged by means of the contactless charging system 1, the primary inductive circuit 3 supplies electromagnetic power by means of the electrical supply network 5 allowing a charging current for the battery 2 to be generated by virtue of the secondary inductive circuit 4.

When an electrical malfunction occurs onboard the automobile vehicle and notably in the charging circuit installed onboard the automobile vehicle, at least one of the relays 9 can open so as to decouple the battery 2 from the rest of the charging circuit, and notably from the secondary inductive circuit 4. In the case where the relays 9 do not open because of a mechanical malfunction of the relays 9 for example, the fuse 11 protects the battery in the case of an over-current and allows it to be disconnected from the secondary inductive circuit 4.

The disconnection of the battery 2 generates an increase in the voltage across the terminals of the control capacitor C_{2f}. In a step 310, the control capacitor C_{2f} provides power for the command to close the controlled switches S₁ and S₂. The closing of the controlled switches S₁ and S₂ leads to the short-circuiting of the secondary inductive circuit 4.

The short-circuiting of the secondary inductive circuit 4 leads to a modification of the electromagnetic interaction between the primary inductive circuit 3 and the secondary inductive circuit 4. In a next step 320, the current on the primary inductive circuit 3 is measured, then in a step 330, the measured current is compared with the detection threshold.

If the measured current is lower than the threshold, the measurement step 320 is restarted, otherwise, in a step 340, the primary inductive circuit 3 is disconnected from the electrical supply network 5.

The invention provides a system for contactless charging of a battery of an automobile vehicle guaranteeing, when an electrical malfunction occurs onboard the vehicle, the interruption of the power emitted by the primary inductive circuit in the ground before any risk of damage onboard the vehicle.

Preferably, the correct operation of the short-circuiting of the secondary inductive circuit 4 is tested prior to the initiation of a charging of the battery 2. For example, if the relays of the battery 2 are closed before the initiation of the charging operation, the resonance capacitor C₂ is charged up by virtue of two resistors that are respectively connected across the terminals of a diode D of the bridge rectifier 8 connected to the capacitor C₂ and to the positive terminal of the battery 2, and across the terminals of a diode D of the bridge rectifier 8 connected to the negative terminal of the battery 2 and to the inductor L₂. The controlled switches S₁ and S₂ are then closed in order to short-circuit the secondary inductive circuit 4. The current in the secondary inductive circuit 4 is then measured, and it is verified that this measured current is higher than a predetermined threshold in order to verify that the secondary inductive circuit 4 has really been short-circuited. If this is the case, the controlled switches S₁ and S₂ are re-opened in order to permit the charging of the battery 2.

As a variant, for example if the relays of the battery 2 are not closed during this test for the correct operation of the short-circuiting of the secondary inductive circuit 4, the secondary inductive circuit 4 is rendered safe, for example by charging the capacitor C_{2f} from the onboard 14V supply of the vehicle. The current in the secondary inductive circuit 4 is then measured, and it is verified that this measured current is higher than a predetermined threshold in order to verify that the secondary inductive circuit 4 has really been short-circuited. If this is the case, the controlled switches S₁ and S₂ are re-opened in order to permit the charging of the battery 2.

1-11. (canceled)

12: A device for receiving an electromagnetic wave for charging of a battery, configured to be installed onboard an automobile vehicle, comprising:
a secondary inductive circuit coupled to the battery via a bridge rectifier;
controlled interruption means configured to short-circuit the secondary inductive circuit without short-circuiting the battery when an electrical malfunction occurs onboard the automobile vehicle; and
a control capacitor for the controlled interruption means coupled in parallel with the battery via relays.

13: The receiving device as claimed in claim 12, further comprising at least one fuse coupled to one of terminals of the battery.

14: A device for emitting an electromagnetic wave for charging of a battery of an automobile vehicle comprising:
a primary inductive circuit powered via a power supply network; and
control means configured to interrupt a power supply to a primary inductive circuit when detecting a short-circuit of the secondary inductive circuit.

15: The emission device as claimed in claim 14, further comprising an inverter coupled to the primary inductive circuit and controlled by the control means, the control means comprising a current sensor configured to measure current flowing in the primary inductive circuit and means for regulation of the current configured to control opening and closing of switches of the inverter.

16: A system for contactless charging of a battery of an automobile vehicle, comprising a receiving device as claimed in claim 12, installed onboard the automobile vehicle, and an emission device disposed outside of the automobile vehicle.

17: A system as claimed in claim 16, wherein the control means comprises a comparison module configured to compare the measured current with a current threshold depending on a level of charge of the battery.

18: A contactless method for charging a battery of an automobile vehicle by inductive transfer of power between a primary inductive circuit outside of the automobile vehicle and a secondary inductive circuit installed onboard the vehicle and coupled to the battery, comprising:
short-circuiting the secondary inductive circuit when an electrical malfunction occurs onboard the automobile vehicle; and
sending a command for disconnection of the primary inductive circuit from the electrical supply network when the short-circuit of the secondary inductive circuit is detected.

19: The method as claimed in claim 18, wherein the short-circuiting of the secondary inductive circuit is controlled using a voltage across terminals of a capacitor connected in parallel with the battery via relays.

20: The method as claimed in claim 18, further comprising measuring current flowing in the primary inductive circuit, and detecting the short-circuit of the secondary inductive circuit based on a variation of the current flowing in the primary inductive circuit.

21: The method as claimed in claim 20, wherein the measurement of the current flowing in the primary inductive circuit is carried out at the resonance frequency of the primary inductive circuit.

22: The method according to claim 20, wherein the measured current is compared with a current threshold depending on a level of charge of the battery.
